(19) United States
(12) Patent Application Publication
(10) Pub. No.: US 2012/0182153 A1
(43) Pub. Date: Jul. 19, 2012

(54) Garage Door Status Indicator and Recorder

(76) Inventor: Kongchith Xamonthiene, Everett, WA (US)

(21) Appl. No.: 13/007,903

(22) Filed: Jan. 17, 2011

(51) Int. Cl. G08B 29/00; G08B 21/00

(52) U.S. Cl. 340/686.1; 340/5.71; 340/5.64

(57) ABSTRACT

A means for recording the status of a garage door as having been left open or having been closed including a garage door sensor, a transmitter and a receiver. Whereas a typical automatic garage door takes 15-20 seconds to become fully closed, an operator will travel less than one-tenth of a mile from their garage in that time. A transmitter emits a one-quarter mile door status signal indicating whether the garage door is closed or open, and a one-quarter mile range signal indicating whether the receiver is within transmission range. Upon leaving transmission range the door status is recorded electrically so that an operator can travel any distance from the garage and determine if the garage door was closed.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to structures made to contain vehicles including garages that utilize a large door for the ingress and egress of vehicles or persons to or from said structures. More specifically, the present invention relates to means for indicating the status of a garage door; more specifically, the present invention relates to means for indicating whether a garage door was closed or opened, at any distance from the garage door.

2. Description of Related Art

The prior art contains garage door status indicators and is comprised of art which contains angle sensing art or actual video surveillance art, or else a combination of both. The prior art however is limited to means for continual monitoring of garage door status, communicating said status either through a home alarm system or else within transmission ranges of up to 100 miles and receivers capable of receiving said transmissions. Often the prior art requires that a transmitter is in constant use at enormous ranges, indicating at all times an open, closed or partially closed status requiring considerable power use and impacting component longevity. The prior art purports to offer progressively inexpensive alternatives without considering power usage.

There does not exist in the prior art, however, the present invention which comprises a means for recording the closed/open status of a garage door used in conjunction with a transmitter, receiver, and garage door sensor such that said status is recorded when said receiver departs the transmission/receiving range of said transmitter and receiver. An operator can thereby travel any distance from the garage door and rely on the recorded status to determine if the garage door was closed. A transmitter is required to only provide a low power, one-quarter mile range signal.

### SUMMARY OF THE INVENTION

The general purpose of the foregoing application is to describe an improved garage door status indicator, including the ability to record the status of a garage door as having been closed or left open after having departed any distance from the garage door.

Given the maximum usable range of a typical garage door remote control (approximately 100 meters) and the 15-20 second typical duration required for a garage door to travel from fully open to fully closed, an operator will reasonably travel less than one-tenth of a mile before a typical garage door is fully closed after using the remote control to close said garage door. Using this approximation, a transmitter and corresponding receiver operate to communicate within a one-quarter mile range of each other. A sensor operates to close an electric circuit when a garage door is fully closed; said circuit is deployed between transmitter and sensor so that when said circuit is closed a door status signal is transmitted to a remote receiver using a specific frequency indicating that the garage door is open. The transmitter emits at all times or intermittently at a lower power level and range as the door status signal, a second signal (herein designated as the “range signal”) on a separate and distinct frequency from the door status signal.

Employed with said receiver is a means for recording the garage door status after an operator has left the one-quarter mile transmission/receiving range, and a visual and/or audio indicating means for communicating said recorded status. Said status recording means comprises, in part, a switching means which operates to control power to the indicating means where loss of range signal causes the switching means to redirect power to the indicating means from the door status signal receiving means to said recording means. Said switching means comprises, in part, the range signal receiving means and thereby communicates with the transmitter via said range signal which is sent at all times from the transmitter. When the range signal receiving means ceases to receive a signal, the switching means diverts power to the indicating means from the status recording means instead of the status signal receiving means. Said indicating means may include, in part, an operator deployable switch that connects power from indicating means to LED lighting means for the purpose of displaying door “Open” status, door “Closed” status, and “In Range” status.

The characteristics and utilities of the present invention described in this summary and the detailed description below are not all inclusive. Many additional features and advantages will be apparent to one of ordinary skill in the art given the following drawings, specifications and claims. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, by explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a purpose of the present invention to indicate the status of a garage door as open or closed.

It is therefore another purpose of the present invention to be robust and able to be inexpensively produced.

It is therefore another purpose of the present invention to operate with any of several types of sensor used to indicate that a garage door is closed or open; types of sensor may include but are not limited to: magnetic, lever type, pressure, conductive elastomer, and any other device which may close a circuit in connection with a garage door bottom or side surface and a transmitter.

It is therefore another purpose of the present invention to operate with any of several types of sensor which may be located on the garage floor proximally to where the bottom edge surface of the garage door meets the garage floor, or on the side of the garage door opening to be used in conjunction with the side edge surface of a garage door.

It is therefore another purpose of the present invention to incorporate a receiver portion into a garage door remote control unit; to incorporate a receiver portion into an automobile feature control or alarm system; or to utilize a receiver as a stand alone device.

It is therefore another purpose of the present invention to operate using any signal generating device as a transmitter, wherein a radio frequency transmission signal is made at any usable frequency to communicate with a receiver.

It is therefore another purpose of the present invention to be energy efficient in design and use: use of a transmitter that only operates up to power signals up to a one-quarter mile range; use of a one-quarter mile range receiver that requires nominal battery or other power; and use of an operator deployable switch to activate indicator display LEDs so that they are not always being powered.

It is therefore another purpose of the present invention to make available at all times, an indication of the status of a garage door perceived either as a current status when within the one-quarter mile range of a transmitter, or as a recorded status after the point when an operator leaves the one-quarter mile range of a transmitter and ceases to receive a signal from it.

It is therefore another purpose of the present invention to be able to indicate at all times whether the receiver is within transmission range of the transmitter.

### (BRIEF) DESCRIPTION OF THE DRAWINGS

The present invention may be better understood, and its numerous features and advantages made apparent to those skilled in the art by referencing the accompanying drawings. For ease of understanding and simplicity, common numbering of elements within the illustrations is employed to identify an element in the different drawings.

FIG. 1 is a plain view of a garage interior; it shows the proximal locations of the garage door, the garage door sensor, and the transmitter.

FIG. 2 is an external perspective view of a stand alone receiver unit.

FIG. 3 is a flowchart diagram describing the operating modes and operation within each mode.

### DETAILED DESCRIPTION

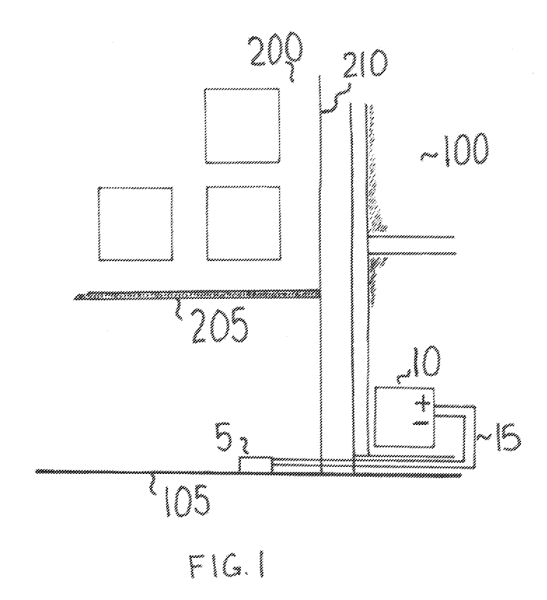

FIG. 1 shows the proximal garage floor 105 location of a floor mounted garage door pressure sensor 5 connected via an electric cable 15 to a transmitter 10 that is attached permanently to a garage wall interior 100. A sensor is comprised of a positive electrode and a negative electrode whereby a circuit is closed between said electrodes when a garage door bottom edge surface 205 ceases to exert pressure on the sensor 5. Said circuit extends through an electric cable 15 to a transmitter 10 that emits two distinct radio frequency signals. In an alternative embodiment, a magnetic sensor 5 may be employed to work in conjunction with the side edge surface of the garage door 210.

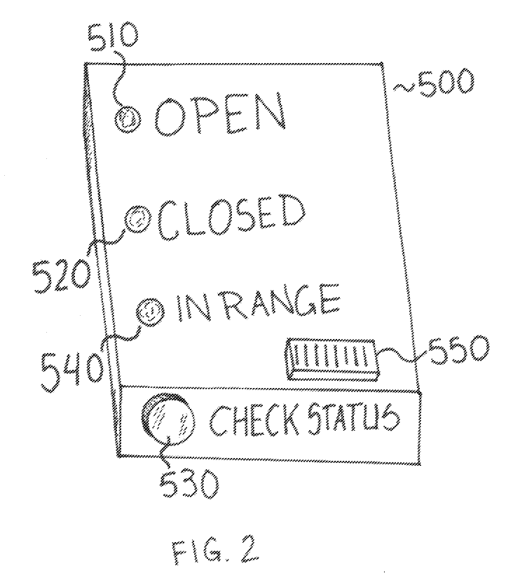

FIG. 2 is a stand alone receiver unit 500 comprising: a durable polymer or metal casing surrounding associated electronic circuitry; a door “Open” LED indicator 510; a door “Closed” LED indicator 520; an “In Range” LED indicator 540; a deployable switch 530 extending through said external casing that sends power to LED indicators 510, 520 and 540; and a grill 550 through which a tone alarm may be heard.

Enclosed by the receiver casing are electronic circuit means including but not limited to: a door status signal receiving means which operates to receive a radio frequency signal transmitted upon garage door opening; a range signal receiving means for receiving a separate and distinct radio frequency signal from that of the door status signal frequency (herein the ‘range signal’); a record status means which has power sent through it when the door status signal receiving means receives a signal, and which is electrically switched closed continuously where the door status signal receiving means receives a signal and where the range signal receiving means does not receive a signal, and remains closed when the door status signal receiving means ceases to receive a signal; and a switching means that: 1) resets the recording means when the range signal receiving means regains a range signal and 2) diverts power from either the door status signal receiving means or the record status means to an indicating means that is employed to send power to diodes, (for example the illustrated LED indicators 510 and 520). In an alternative embodiment, a signal processing means is employed, in part, to control the switching means and the recording means.

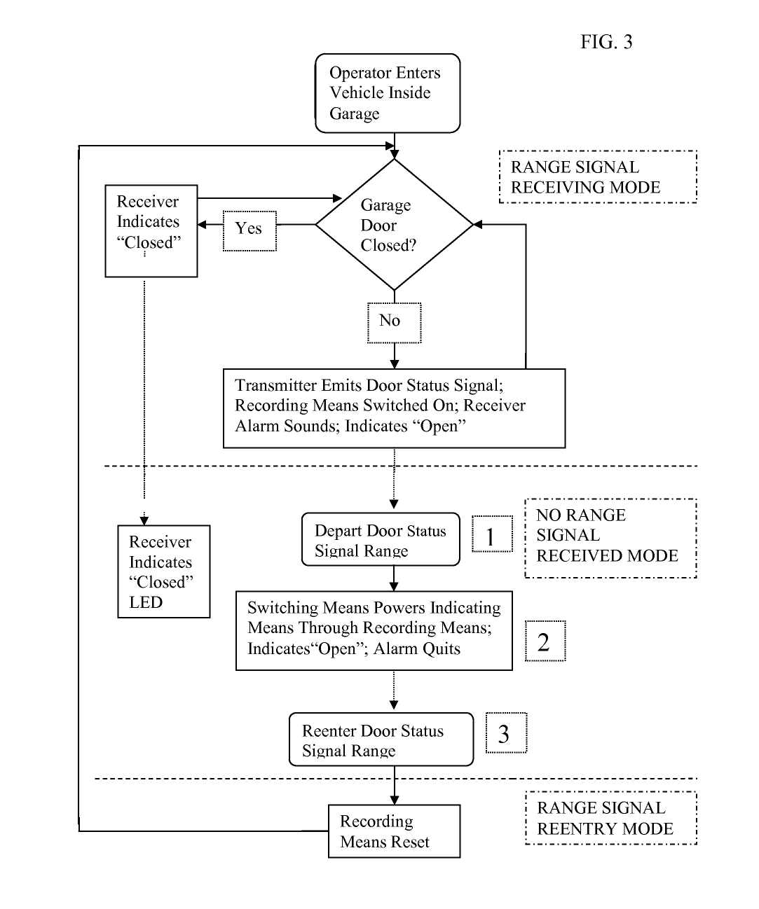

FIG. 3 is a flowchart depicting the operation of the receiver 500 in use. Three interdependent modes are employed that correspond to whether the receiver is receiving a range signal: when the receiver is receiving a range signal (Range Signal Receiving Mode); when a receiver is not receiving a range signal (No Range Signal Received Mode); and when the receiver 500 regains a range signal (Range Signal Reentry Mode). A vehicle, located in a garage equipped with the present invention, contains inside of it a receiver either as a stand alone unit 500, as incorporated in a garage door opener remote control unit, or as incorporated into a vehicle feature control system. While a garage door bottom edge 205 depresses a garage door pressure sensor 5 located on the garage floor underneath the garage door bottom edge 205, no door status signal is sent to said receiver from the transmitter 10 and a door closed status is indicated electronically within the receiver. Upon opening a garage door 200 as a means of vehicle egress, said door status signal receiving means receives a door status signal from the transmitter 10 and a door open status is indicated within the receiver electronically. When a door status signal is received by the door status signal receiving means, a record status means is powered such that upon exiting range signal transmission range the record status circuit remains closed. A switching means diverts power to the indicating means from the record status means instead of the door status signal receiving means after a range signal receiving means ceases to receive a range signal from the transmitter 10. An operator can thereby determine if the receiver is in range signal transmission range and, if not a range signal is not being received, what the status of the garage door 200 was at the point when the receiver left range signal transmission range. Upon reentering range signal transmission range, the range signal means activates the switching means so that first the recording means is reset by the status of the signal receiving means and then power to the indicating means is sent from the signal receiving means.

The previous is a detailed description of illustrative embodiments of the present invention. As these embodiments of the present invention are described with references to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense, as it is understood that the present invention is in no way limited to the embodiments illustrated.

A garage door status indicator and recorder comprising:

What is claimed is:

1. A garage door sensing means, a signal generating means, a receiver means and a recording means whereby: said signal generating means and said receiver means include a power source and whereby said recording means may have an independent power source.

2. The garage door sensing means of claim 1 operating to close an electric circuit upon the opening or closing of a garage door and including but not limited to the following sensing means: a pressure sensor; a lever type sensor; a magnetic sensor; or any means capable of closing an electric circuit upon the closing or opening of a garage door.

3. The signal generating means of claim 1 operating to transmit a door status signal via a door status signal generating means so as to operate in connection with the closing of the electric circuit of claim 2 upon the opening or closing of a garage door whereby said door status signal is a radio frequency signal of any frequency.

4. The signal generating means of claim 1 operating to transmit a range signal via a range signal generating means whereby:
a single range signal or a plurality of said range signals may be employed and whereby said range signal or signals is/are the same or different frequency or frequencies as that of the door status frequency of claim 3; and
said range signal is a radio frequency signal emitted at the same power level and/or at a different power level and/or signal pattern of the door status signal of claim 3.

5. The receiver means of claim 1 operating to: receive the door status signal of claim 3 via a door status signal receiving means, and the range signal of claim 4 via a range signal receiving means; record the status of a garage door as being open or closed via the recording means of claim 1; and to indicate said recorded status via an indicating means whereby:
a suitable arrangement of electrical components and circuit elements are arranged and configured to operate the receiver means of Claim land may include a signal processing means;
said arrangement of electrical components and circuit elements are:
encased in a protective casing as a stand alone device;
incorporated into a device used activate a garage door opening or closing means; or
incorporated into the electronic circuitry located in a vehicle;
said arrangement of electrical components and circuit elements operates in different interdependent modes including:
a Range Signal Receiving Mode wherein said range signal receiving means is receiving the range signal of claim 4 and said door status signal receiving means is receiving the door status signal of claim 3, whereby a switching means operates to cause said door status signal receiving means to send power to said recording means and said indicating means;
a No Range Signal Received Mode wherein said range signal receiving means is not receiving the range signal of claim 4 and whereby: said switching means operates to cause said recording means to send power to an indicating means where said door status signal receiving means continues to receive a door status signal and where said switching means causes said recording means to remain electrically switched closed even where said door status signal receiving means ceases to receive a door status signal;
a Range Signal Reentry Mode wherein said range signal receiving means regains the range signal of claim 4 whereby: said switching means operates to first reset said recording means and to then cause said arrangement of electrical components and circuit elements to enter said Range Signal Receiving Mode.

6. The Indicating means of claim 5 includes but is not limited to an arrangement of electronic circuitry or components including but not limited to: diodes that operate singularly as part of an LED lamp, or in a plurality as part of a display, that are connected electrically to the door status signal receiving means of claim 5 and the recording means of claim 1 and that operate to communicate door status to an operator as open or closed; and/or diodes that operate to communicate whether the range signal receiving means of claim 4 is receiving the range signal of claim 4.
